(19) United States
(12) Patent Application Publication
(10) Pub. No.: US 2011/0099327 A1
(43) Pub. Date: Apr. 28, 2011

(54) SYSTEM AND METHOD FOR LAUNCHING AN APPLICATION PROGRAMMING UTILIZING A HYBRID VERSION OF DEMAND PAGING

(75) Inventor: Wladyslaw Bolanowski, Bara (SE)

(73) Assignee: SONY ERICSSON MOBILE COMMUNICATIONS AB, Lund (SE)

(21) Appl. No.: 12/641,472

(22) Filed: Dec. 18, 2009

Related U.S. Application Data
(60) Provisional application No. 61/255,470, filed on Oct. 27, 2009.

(51) Int. Cl. G06F 12/00; G06F 9/44

(52) U.S. Cl. 711/104; 719/313; 711/154; 711/E12.001

(57) ABSTRACT

A system and method for launching a computer application program stored in a nonvolatile medium, wherein by reusing a page load scheme from a standard demand page based launch. The system and method includes launching a computer application program one or more times using demand paging to load memory pages of the nonvolatile medium associated with the computer application into a volatile memory for execution of the computer application program. Memory address information corresponding to the pages of the nonvolatile medium corresponding to portions of the computer application program accessed during use of the computer application program are stored in a launch record. The computer application program is launched using the address information stored in the launch record to read nonvolatile medium addresses stored in the launch record in a single or consecutive read step.

### RELATED APPLICATION DATA

This application claims priority from U.S. Provisional Patent Application Ser. No. 61/255,470 filed on Oct. 27, 2009, which is incorporated herein by reference.

### TECHNICAL FIELD OF THE INVENTION

The technology of the present disclosure relates generally to a system and method for launching an application program. The method and system launches computer applications by re-using a page load scheme from a standard demand page based launch.

### BACKGROUND

Electronic devices store data, which can be either data related to characteristics of a device or executable code required for the execution of functions and/or computer application programs for the device. Such electronic devices use a virtual memory technique to efficiently store and manage data.

In the virtual memory technique, a volatile storage medium and a nonvolatile storage medium are mapped to manage data and code and demand paging is performed to retrieve from the nonvolatile storage medium to the volatile storage medium only data or code that is needed. Demand paging is a method for reading only data or code that is required for a specific process from the nonvolatile storage medium, temporarily downloading the data or code to the RAM, and reading, e.g., using, the data or code from the physical storage medium. In the execution of demand paging, the only information read (e.g., data and/or code) is information that is required for a process and for rapidly processing the information in the volatile storage medium, e.g., a high speed RAM.

With the development of mobile equipment, more functions are gradually added to the mobile equipment to realize a more convenient mobile environment. Adding more functions to the mobile equipment requires an increase in the amount of software or a demand for RAM. This is followed by an increase in an amount of RAM needed in a device. However, RAM is a relatively expensive resource.

In recent years, a demand for cheap electronic devices is also increasing at the same time. Thus, in order to meet the problem of two conflicting requirements, RAM has to be more efficiently used in order to enable a lesser amount of RAM to be needed.

In a general environment such as a Personal Computer (PC), which is not the mobile environment, the above requirements are satisfied using a virtual memory technique. In the virtual memory technique, disk resources that are slower but much cheaper than RAM are virtualized as if they were RAM and the contents of a disk, e.g., a nonvolatile storage medium, are mapped to a partial buffer of a RAM, e.g., a volatile storage medium, and used whenever they are needed. Only part of the code stored in the disk is required to process a specific process. Thus, the virtual memory technique shifts only content needed at a specific time point from the disk to the RAM and performs a process, thereby enhancing a degree of use of the RAM.

In the mobile environment, a nonvolatile memory (e.g., a Not AND (NAND) flash memory or other flash memory or nonvolatile memory) is a nonvolatile storage medium that functions as a disk of the mobile equipment. The nonvolatile storage medium can store a large capacity of data or code despite its simple structure.

A virtual memory used in the general PC environment has changeable content. Thus, when the content is no longer needed in a caching buffer, changed content is rewritten to a disk so that the changed content can be henceforth referred to according to need. The mobile equipment performs demand paging for only unchangeable data (that is, read only data) and therefore, does not have to swap out content to the nonvolatile memory, etc.

FIG. 1 is a flow diagram illustrating a conventional demand paging process. In the case where an electronic device intends to carry out a specific process, the device reads data or code stored in a flash memory and/or other nonvolatile storage medium (e.g., a disk storage medium). Initially, the electronic device secures a memory space in a RAM to store read data and/or code therein in block 10. Then, the electronic device determines whether demand paging or store and download is to be used to carry out the process, at block 12. If demand paging is to be used, the electronic device transfers the data or code from the flash memory through demand paging and temporarily stores the data or code in RAM at block 14. On the other hand, if store and download is to be used, the electronic device copies the data or code, which have been loaded into RAM, into a caching buffer and temporarily stores the data or code in the caching buffer, at block 16. Then, the electronic device processes a specific process using the loaded data or code in block 18. Thus, the demand paging technique provides an advantage of being capable of greatly reducing a needed capacity of RAM for code execution because an amount of RAM used for code execution can be reduced by a size of the caching buffer from a size of all of the code.

### SUMMARY

Code execution by demand paging means that code pages (e.g., pages of nonvolatile memory) are requested from the nonvolatile memory and/or a disk resource when actually needed for the execution. When a new application is being launched, it means that a lot of individual pages will be read from nonvolatile memory and/or disk resource. In the case that there is just one channel available to the nonvolatile memory (e.g., for NAND memory), which means that read and write operations cannot be processed in parallel and assuming some kind of raising of the priority of reading the code pages compared to write operations and ordinary read operations, it might make a temporary blocking of the file system.

The present disclosure overcomes the above problems by defining a system and method for optimal launching of computer applications by reusing a page load scheme from a standard demand page based launch. One or more of the following steps may be used to implement aspects of the claimed invention:

A plan for launching one or more computer application programs is defined. For example, computer application program may utilize store and download, demand paging or hybrid demand paging. For purposes of describing aspects of the invention, it is assumed that hybrid demand paging is desired for at least one or more of the computer application programs. For hybrid demand paging, a launch record is created for data related to the launch of a computer application program. The launch record may include a flag to signify if hybrid demand paging is enabled for launching of a particular computer application. In one embodiment, a number of trials (e.g., a predetermined number of computer application launches) may be desired to enable hybrid demand paging, which will enable a more accurate reflection of memory page data associated with a particular computer application. Each launch record may include memory page data containing logical block addresses of pages that define an optimal application launch each computer application program launched on the electronic device. When the computer application program is launched that has not been enabled for hybrid demand paging, the computer application will be launched using demand paging in a conventional manner, wherein each of the fetched addresses will be stored in a temporary address chain buffer for storing in the launch record associated with the correspond computer application program.

When the number of launches for a computer application program reaches the predetermined number of trials, the computer application program may then be enabled for hybrid demand paging. The temporary chain of buffers of memory pages may be analyzed in order to find most optimal launch scheme. It might be that most common scheme will be chosen, a superset of the launching schemes or some combination may be selected. An algorithm may be used to choose the optimal launch scheme. This optimal scheme will be stored in the launch record to define page data containing logical block addresses of pages that define the optimal application launch or another application launch sequence. When launching a computer application that has been enable with hybrid demand paging, all memory pages contained in the logical block addresses of pages stored in the launch record will be read by one sequential read operation. Afterwards, the standard demand paging mechanism will be enabled to allow fetching a memory pages that are not in volatile memory.

One aspect of the invention relates to a method for launching a computer application program stored in a nonvolatile medium of an electronic device, the method includes: receiving a command to launch a computer application program, wherein the computer application program is stored on one or more pages of a nonvolatile medium of an electronic device; identifying the application program to be launched, wherein the step of identifying includes reading a launch record associated with the application program, wherein the launch record includes addresses of the one or more pages of the nonvolatile medium that were previously used to execute the computer application program; and launching the computer application program by reading the launch record and loading the one or more pages of nonvolatile medium into a volatile memory for execution of the computer application program, wherein a single read or one or more continuous reads are used to load the one or more pages of the nonvolatile medium identified in the launch record in the volatile memory.

Another aspect of the invention relates to the launch record being created by performing demand paging to launch the computer application program.

Another aspect of the invention relates to the computer application program being launched a predetermined number of times and nonvolatile addresses associated with launching and execution of the computer application program are monitored and stored in the launch record.

Another aspect of the invention relates to the when computer application program has launched the predetermined number of times, the launch record has a hybrid demand paging flag set, wherein the hybrid demand paging flag signifies that the computer application program is to be launched based on information stored in the launch record.

Another aspect of the invention relates to the predetermined number of times of the computer application launching being less than ten launches of the computer application program.

Another aspect of the invention relates to a user initiating launching of the computer application program.

Another aspect of the invention relates to the volatile memory being a Random Access Memory (RAM).

Another aspect of the invention relates to the single read or one or more continuous reads being used to load the computer application program to be launched.

Another aspect of the invention relates to launch records associated with launched computer application programs being stored in nonvolatile medium and loaded in volatile memory when the electronic device is in an “on” state.

Another aspect of the invention relates to each of the launch records include a field to identify a type of memory read to launch the computer application program and one or more nonvolatile medium locations associated with use of the computer application program, wherein the nonvolatile medium locations include addresses that were obtained by direct paging of the nonvolatile medium from one or more previous launches of the computer application program.

One aspect of the invention relates to a method for launching a computer application program stored in a nonvolatile medium, the method includes: launching a computer application program one or more times using demand paging to load pages of a nonvolatile medium associated with the computer application into a volatile memory for execution of the computer application program; storing address information corresponding to the pages of the nonvolatile medium corresponding to portions of the computer application program accessed during use of the computer application program, wherein the memory address information is stored in a launch record that is associated with the computer application; launching the computer application program using the address information stored in the launch record to read nonvolatile medium addresses stored in the launch record in a single or consecutive read step.

Another aspect of the invention relates to the read step is performed continuously until the computer application program to be loaded is launched.

Another aspect of the invention relates to the launch record being created upon performing demand paging to load the volatile memory with contents of the nonvolatile medium associated with the computer application program to launch the computer application program.

Another aspect of the invention relates to each time the computer application program is launched by demand paging, nonvolatile storage addresses associated with launching and execution of the computer application program are monitored and stored in the launch record.

Another aspect of the invention relates to once the computer application program has launched the predetermined number of times, the launch record has a hybrid demand paging flag set, wherein the hybrid demand paging flag signifies that the computer application program is to be launched based on information stored in the launch record.

Another aspect of the invention relates to the launch records associated with launched computer application programs being stored in a nonvolatile medium and loaded in volatile memory when the electronic device is in an “on” state.

Another aspect of the invention relates to each of the launch records including a field to identify a type of nonvolatile storage read to launch the computer application program and one or more nonvolatile medium locations associated with use of the computer application program, wherein the nonvolatile medium locations include addresses that were obtained by direct paging of the nonvolatile medium from one or more previous launches of the computer application program.

One aspect of the invention relates to a method for launching a computer application program stored in a nonvolatile medium of an electronic device, the method including: receiving a command to launch a computer application program, wherein the computer application program is stored on one or more pages of a nonvolatile medium of an electronic device; reading a launch record associated with computer application program, wherein the launch record is stored in volatile memory; and processing the launch record to determine if demand paging is to be used to load one or more pages of nonvolatile medium into a volatile memory, wherein each of the one or more pages are loaded into volatile memory when needed by the electronic device or hybrid demand paging is to be used to load the one or more pages of nonvolatile medium into the volatile memory, wherein hybrid demand paging utilizes address information stored in the launch record, wherein the address information includes each of the one or more pages of nonvolatile medium previously used by the electronic device when the computer application program previously executed and the volatile memory is loaded with the contents identified by the address information in a single or consecutive read steps.

Another aspect of the invention relates to the address information stored in the launch record being accumulated by loading the computer application program using demand paging.

One aspect of the invention relates to an electronic device including: a nonvolatile medium for storing one or more computer application programs wherein the computer application program is stored on one or more pages of the nonvolatile medium; a volatile memory for launching the one or more computer application programs; a controller coupled to the nonvolatile medium and the volatile memory, wherein the processor receives a request to launch one or more of the computer application programs, the controller is configured to: read a launch record associated with the one or more application programs, wherein the launch record includes addresses of the one or more pages of the nonvolatile medium that were previously used to execute the computer application program; and launching the computer application program by reading the launch record and loading the one or more pages of nonvolatile medium into a volatile memory for execution of the computer application program, wherein a single read or one or more continuous reads are used to load the one or more pages of the nonvolatile medium identified in the launch record in the volatile memory.

One aspect of the invention relates to an electronic device including: a nonvolatile medium for storing one or more computer application programs wherein the computer application program is stored on one or more pages of the nonvolatile medium; a volatile memory for launching the one or more computer application programs; a controller coupled to the nonvolatile medium and the volatile memory, wherein the processor receives a request to launch one or more of the computer application programs, the controller is configured to: launch the one or more computer application programs one or more times using demand paging to load the memory pages of nonvolatile medium associated with the computer application into the volatile memory for execution of the computer application program; store memory address information corresponding to the memory pages of the nonvolatile medium corresponding to portions of the computer application program accessed during use of the computer application program, wherein the memory address information is stored in a launch record that is associated with the computer application; and launch the computer application program using the address information stored in the launch record to read memory addresses stored in the launch record in a single or consecutive read step.

These and further features will be apparent with reference to the following description and attached drawings. In the description and drawings, particular embodiments of the invention have been disclosed in detail as being indicative of some of the ways in which the principles of the invention may be employed, but it is understood that the invention is not limited correspondingly in scope. Rather, the invention includes all changes, modifications and equivalents coming within the scope of the claims appended hereto.

Features that are described and/or illustrated with respect to one embodiment may be used in the same way or in a similar way in one or more other embodiments and/or in combination with or instead of the features of the other embodiments.

It should be emphasized that the term “comprises/comprising” when used in this specification is taken to specify the presence of stated features, integers, steps or components but does not preclude the presence or addition of one or more other features, integers, steps, components or groups thereof.

Many aspects of the invention can be better understood with reference to the following drawings. The components in the drawings are not necessarily to scale, emphasis instead being placed upon clearly illustrating the principles of the present invention. To facilitate illustrating and describing some parts of the invention, corresponding portions of the drawings may be exaggerated in size, e.g., made larger in relation to other parts than in an exemplary device actually made according to the invention. Elements and features depicted in one drawing or embodiment of the invention may be combined with elements and features depicted in one or more additional drawings or embodiments. Moreover, in the drawings, like reference numerals designate corresponding parts throughout the several views and may be used to designate like or similar parts in more than one embodiment.

### BRIEF DESCRIPTION OF THE DRAWINGS

FIG. 1 is a flow diagram illustrating conventional demand paging process.

FIG. 2 is an exemplary embodiment of an electronic device in accordance with aspects of the present invention.

FIG. 3 is a schematic block diagram of the exemplary electronic device of FIG. 2.

FIGS. 4-5 are exemplary flow diagrams illustrating various aspects of launching a computer application program in accordance with aspects of the present invention.

FIGS. 6-8 are exemplary methods of launching a computer application program in accordance with aspects of the present invention.

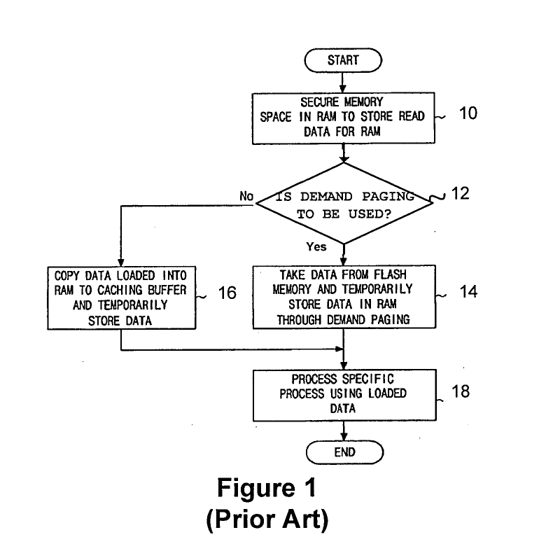

### DETAILED DESCRIPTION OF EMBODIMENTS

Embodiments will now be described with reference to the drawings, wherein like reference numerals are used to refer to like elements throughout. It will be understood that the figures are not necessarily to scale.

Described below in conjunction with the appended figures are various embodiments of an improved system and method for launching one or more computer application programs. Although the invention will be described in connection with a mobile telephone, it will be appreciated that aspects of the disclosed method may be applied to other electronic devices such as, but not limited to, cameras, music players, personal digital assistants, desktop computers, laptop computers, tablet computers, netbook computers, etc.

The present invention provides a system and method for optimal launching of computer application programs by reusing a page load scheme from a standard demand page based launch the pages may be stored in nonvolatile storage (e.g., a memory, disk storage, etc.).

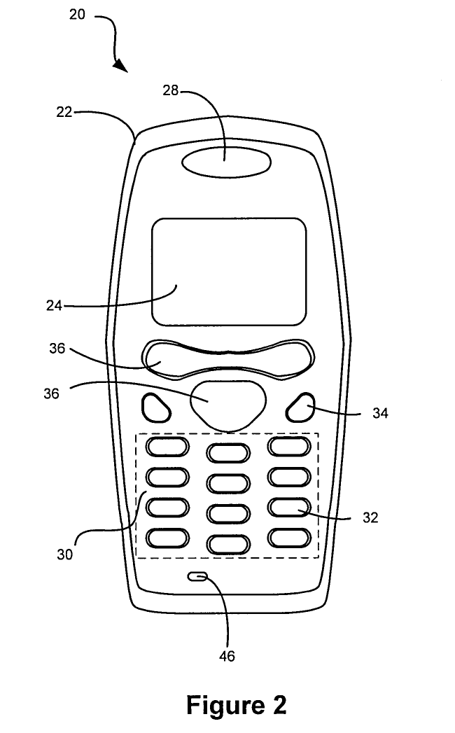

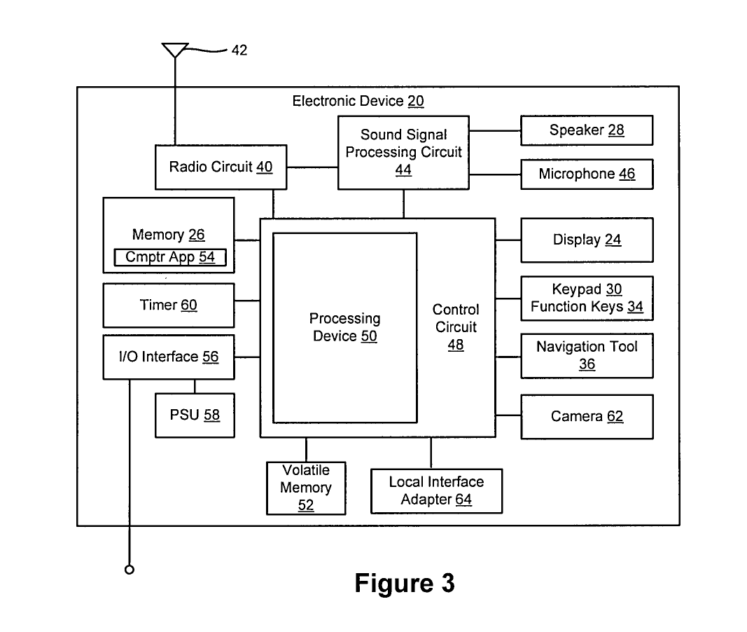

Referring initially to FIGS. 2 and 3, an electronic device 20 in the form of a mobile telephone is illustrated. The mobile telephone 20 is shown as having a “brick” or “block” design type housing 22, but it will be appreciated that other type housings, such as a clamshell housing or a slide-type housing, may be utilized without departing from the scope of the invention. The mobile telephone 20 includes a display 24. The display 24 displays information to a user such as operating state, time, telephone numbers, contact information, various navigational menus, etc., which enables the user to utilize the various feature of the mobile telephone 20. The display 24 may also be used to visually display content accessible by the mobile telephone 20 from one or more remote sources (e.g., a media server, a network, etc.). The displayed content may include audio and/or video presentations stored locally in nonvolatile memory 26 (FIG. 3), a disk storage medium (not shown) of the mobile telephone 20 and/or stored remotely from the mobile telephone 20 (e.g., on a remote storage device, a media server, remote personal computer, etc.). Such presentations may be derived, for example, from multimedia files, including audio and/or video files, from a received mobile radio and/or television signal, etc. In many situations, the video presentations are accompanied by audio presentations. For example, the displayed video component may be a “music video” and the corresponding audio component may be music intended to be synchronized with the video component. As another example, the displayed video component may correspond to a received mobile television signal and the corresponding audio component may be speech and/or music intended to be synchronized with the video component. The audio component may be broadcast to the user with a speaker 28 of the mobile telephone 20.

The mobile telephone 20 further includes a keypad 30 that provides for a variety of user input operations. For example, the keypad 30 may include alphanumeric keys 32 for allowing entry of alphanumeric information such as telephone numbers, phone lists, contact information, notes, etc. In addition, the keypad 30 typically may include special function keys 34 such as a “call send” key for initiating or answering a call, and a “call end” key for ending, or “hanging up” a call. A navigation tool 36 may also be included to allow the user to easily toggle and or move a cursor on the display and/or for assisting a user to navigate through a menu displayed on the display 24 to select different telephone functions, profiles, settings, etc., as is conventional. Other keys associated with the mobile telephone 20 may include a volume key, audio mute key, an on/off power key, a web browser launch key, a camera key, etc. Keys or key-like functionality may also be embodied as a touch screen associated with the display 24. One or more the above input devices (e.g., keypad 30, function keys 34, navigation tool 36) may be used by a user to select an application to execute on the mobile telephone 20.

The mobile telephone 20 includes conventional call circuitry (e.g., radio circuit 40) that enables the mobile telephone 20 to establish a call and/or exchange signals with a called/calling device, typically another mobile telephone or landline telephone. However, the called/calling device need not be another telephone, but may be some other device such as an Internet web server, content providing server, etc.

Continuing to refer to FIGS. 2 and 3, the mobile telephone 12 includes an antenna 42 coupled to a radio circuit 40. The radio circuit 40 includes a radio frequency transmitter and receiver for transmitting and receiving signals via the antenna 42 as is conventional. The mobile telephone 20 generally utilizes the radio circuit 40 and antenna 42 for voice, Internet and/or E-mail communications over a cellular telephone network. The mobile telephone 20 further includes a sound signal processing circuit 44 for processing the audio signal transmitted by/received from the radio circuit 40. Coupled to the sound processing circuit 44 are the speaker 28 and a microphone 46 that enable a user to listen and speak via the mobile telephone 20 as is conventional. The radio circuit 40 and sound processing circuit 44 are each coupled to the control circuit 48 so as to carry out overall operation.

Referring to FIG. 3, a functional block diagram of the electronic device 20 is illustrated. The mobile telephone 20 includes a primary control circuit 48 that is configured to carry out overall control of the functions and operations of the mobile telephone 20. The control circuit 48 may include a processing device 50, such as a CPU, microcontroller or microprocessor. The processing device 50 executes code stored in a memory (not shown) within the control circuit 48 and/or in a separate memory, such as nonvolatile memory 26 and/or volatile memory 52, in order to carry out conventional operation of the mobile telephone 20. The memory 26 may be, for example, a buffer, a flash memory, a hard drive, a removable media, and/or any type of device that is capable of storing contents when power has been removed from the device. The volatile memory 52 may be, for example, a buffer, RAM or any other source of volatile electronic storage. In addition, the processing device 50 executes code to carry out various functions of the mobile telephone 20.

The nonvolatile memory 26 may include one or more computer application programs 54 for performing one or more tasks or functions. For example, the memory 26 may include one or more programs stored in the memory and may transfer contents to volatile memory 52 when a computer program application is launched to execute the computer application program. Although not shown, one or more computer application programs 54 may also be stored on a disk storage medium (e.g., a hard disk drive).

The mobile telephone 20 also includes the aforementioned display 24, keypad 30, function keys 34 and navigation tool 36 coupled to the control circuit 48. The mobile telephone 20 further includes an I/O interface 56. The I/O interface 56 may be in the form of typical mobile telephone I/O interfaces, such as a multi-element connector at the base of the mobile telephone 20. As is typical, the I/O interface 56 may be used to couple the mobile telephone 20 to a battery charger to charge a power supply unit (PSU) 58 within the mobile telephone 20. In addition, or in the alternative, the I/O interface 56 may serve to connect the mobile telephone 20 to a wired personal hands-free adaptor, to an external electronic device (e.g., personal computer or other device) via a data cable, etc. For example, the I/O interface 56 may be a universal port that may be coupled to a cable to connect the mobile telephone 20 to a personal computer. The universal port may be a universal serial bus (USB) port, which receives a USB cable for connection to a USB port of a personal computer.

The mobile telephone 20 may also include a timer 60 for carrying out timing functions. Such functions may include timing the durations of calls, generating the content of time and date stamps, etc.

The mobile telephone 20 may include various built-in accessories, such as a camera 62 for taking digital pictures. Image files corresponding to the pictures may be stored in the memory 26. In one embodiment, the mobile telephone 20 also may include a position data receiver (not shown), such as a global positioning satellite (GPS) receiver, Galileo satellite system receiver or the like.

To establish wireless communication with other locally positioned devices, such as a headset, another mobile telephone, a computer, etc., the mobile telephone 20 may include a local wireless interface adapter 64, such as a Bluetooth adaptor, infrared adapter, near field communication adapter, etc. The wireless interface adapter 64 will generally enable the mobile telephone 20 to communicate with a variety of electronic devices.

Methods for launching a computer application program 54 stored in a nonvolatile memory 26 of an electronic device 20 will now be discussed. As explained in detail below, these methods define launching of computer program applications by reusing a page load scheme from a standard demand page based launch. One skilled in the art will readily appreciate that the following methods are exemplary in nature and that the steps outlined below may occur in any order.

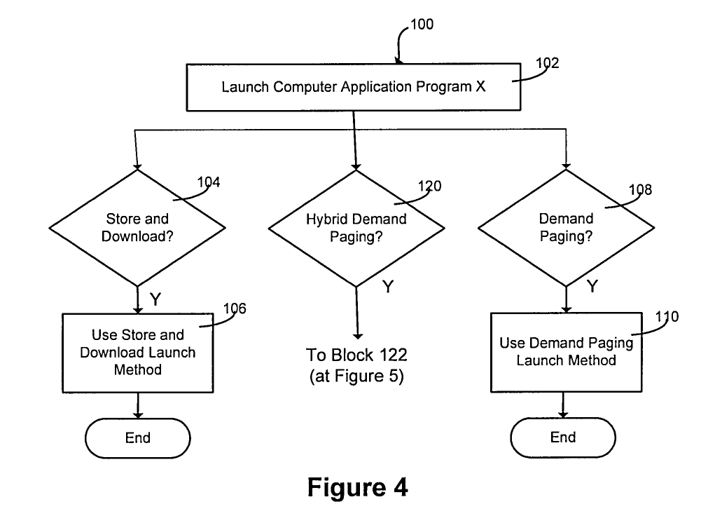

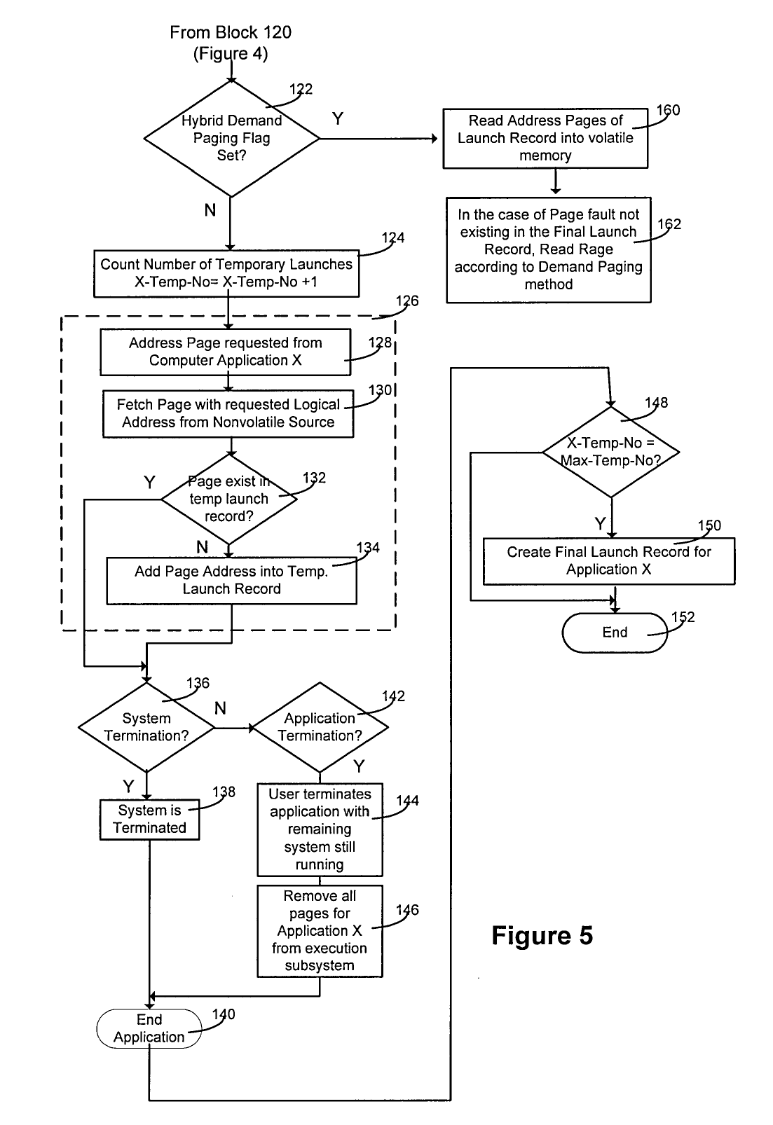

Referring to FIG. 4, an exemplary method 100 for launching a computer application program stored in nonvolatile storage medium (e.g., nonvolatile memory 26, a disk storage medium, etc.) of an electronic device is illustrated.

The method 100 includes, at block 102, receiving a command to launch a computer application program, wherein the computer application program is stored on one or more pages of a nonvolatile flash memory 26 of an electronic device 20 and/or in a disk storage medium associated with the electronic device 20. The computer application program may be stored in any type of nonvolatile memory (e.g., memory 26, a disk storage medium, etc.). The command to launch a computer application program may be initiated by a user, the control circuit 48, by another application or by any other means.

The computer application program is configured to launch as a store and download manner, a hybrid demand paging manner or a demand paging manner. Generally every application is configured to be launched in at least one of these manners. For purposes of illustration, the following description will illustrate launching of computer application program in each case.

If the computer application program is to be launched using a store and download method, signal flow is directed to block 104. Under the store and download approach, all system code and data associated with the selected computer application program is loaded into volatile memory before execution of the selected computer application program, as illustrated at block 106. The store and download method has a variety of drawbacks including, for example, increased volatile memory requirements, increase time before application launch, etc. Once all of the system code and data associated with the selected computer program application is loaded in volatile memory (e.g., RAM), the launch has succeeded and the program has been successfully launched.

If the computer application program is to be launched using a demand paging approach, signal flow is directed to block 108. At block 110, demand paging is used to launch the computer application program. As explained above, demand paging operates to copy pages from a nonvolatile memory and/or disk storage element, as required, by the computer application program during execution. As explained above there are problems with launch a computer application program using demand paging. Such problems include, for example, a lot of individual pages will be read from nonvolatile memory and/or disk resource when a new application is launched; and when there is just one channel available to the nonvolatile memory, read and write operations cannot be processed in parallel and may result in temporary blocking of the file system due to an inability to prioritize between reading and writing functions.

If the computer application program is to be launched using hybrid demand paging, control is directed to block 120. Referring to FIG. 5, at block 122, a determination is made as to whether to launch the computer application program using hybrid demand paging. Such a determination may be made in a number of ways. For example, a launch record associated with the computer application program to launch may contain a field for enabling hybrid demand paging. When the flag is set, for example, the computer application program may launch using hybrid demand paging. When the flag is not set, the computer application program may launch using demand paging, for example, or another launching method.

Referring to FIG. 5, if the hybrid demand paging is not enabled (e.g., the hybrid demand page flag is not set), control is directed to block 124. At block 124, in order to get a sampling of the pages of memory and/or disk storage medium that should be stored in a launch record, a number of temporary launch records are collected. The temporary launch records may be stored together as sub-records, stored individually, etc. When flow reaches block 124, the count associated with the number of temporary launches for a computer program application is increased by 1 and an additional temporary launch record for the current launch may be created.

At block 126, a temporary launch record associated with the current computer program application launch is created. The temporary launch record may be created in any desirable manner. One such exemplary manner includes at block 128, a page is requested from the computer application program during launch of the computer application program. Note: this step could be accomplished using demand paging. Furthermore, the requested page could be stored in any non-volatile storage medium (e.g., non-volatile memory, disk storage medium, etc.)

At block 130, the page address requested during launch of the computer application program is fetched from the nonvolatile storage medium. At block 132, a determination is made as to whether the requested page address exists in the temporary launch record. If the page does not exist in the temporary launch record, at block 134, the page address is added to the temporary launch record and saved.

Once the computer application program is terminated and/or another computer application program (e.g., a second computer application program) is launched, control flows to block 136. At block 136, a determination is made as to whether the determination was a system termination. If the termination was a system termination, at block 138, the system is terminated and at block 140, the application is terminated.

If the determination was that a system termination did not occur, program flow moves to block 142. At block 142, a determination is made as to whether an application termination occurred. If an application termination occurred, program flow moves to block 144. At block 144, the user terminates the computer program application with the remaining system still running. At block 146, all pages stored in volatile memory that are associated with the computer application program may be removed from the volatile memory. Termination of the computer application program may include clearing the logical page address from volatile memory in order to create a clear basis for the next launch. Program flow then proceeds to block 140 and the application is terminated.

When program flow reaches block 140, whether from a system termination or a computer program application termination, program flow progresses to block 148. At block 148, a determination is made as to whether a computer application program has been launched a predetermined number of times. The predetermined number of times may be any desired number of times. Generally, fewer than five application launches may be deemed a suitable number of times to obtain page addresses that an associated user uses during a typical launch of the selected computer application program. One of ordinary skill in the art will readily appreciate that number of application launches deemed suitable may depend on a variety of factors including, for example, type of application, user interaction, etc.

If the application has launched a predetermined number of times, a final launch record (also referred to herein as an “established launch record” is then created for the computer application program, as shown in block 150. Generally, the final launch record includes, a flag set in the hybrid demand paging field.

In addition, the launch record also includes a set or subset of all page addresses stored in one or more of the temporary launch records. One or more algorithms may be used to determine whether to include a logical address from a nonvolatile source in the launch record. For example, if a logical address page was used in one-half or more of the launchings of the computer application program, it may be desirable to include these memory locations in an established launch record. Of course, other metrics may be used to populate the memory locations of the established launch record. For example, while the establish launch record may be used to launch the computer application program, sub-records associated with the launch record may be used to determine if one or more addresses should be added and/or deleted from the established launch record. For example, over a period of time a user's use of a computer application program may change. Therefore, it may be desirable to update the established launch record accordingly.

Once the final launch record is created, program flow proceeds to block 152 for termination of the sub-routine. If the condition set forth in block 148 is not met, program flow proceeds to block 102 to monitor for a launch of another computer application program.

As illustrated in FIG. 5, control flows to blocks 124-152 when the number of temporary launches is less than or equal to a predetermined number of launches for a particular computer application program. When a computer application program has launched the predetermined number of times and a launch record has been created (also referred to herein as an established launch record), the hybrid demand paging flag is set in a field in the associated header.

An established launch record is a launch record that has launched more than the predetermined number of times. Once the computer application program has launched the predetermined amount of times and the hybrid demand paging flag is set, from block 122 control moves to block 160. At block 160, address pages contained in the launch record are read into volatile memory and launched. If during launching and/or execution a page fault that does not exist in the final launch record is requested, the requested page may be read using a demand paging method, as discussed above.

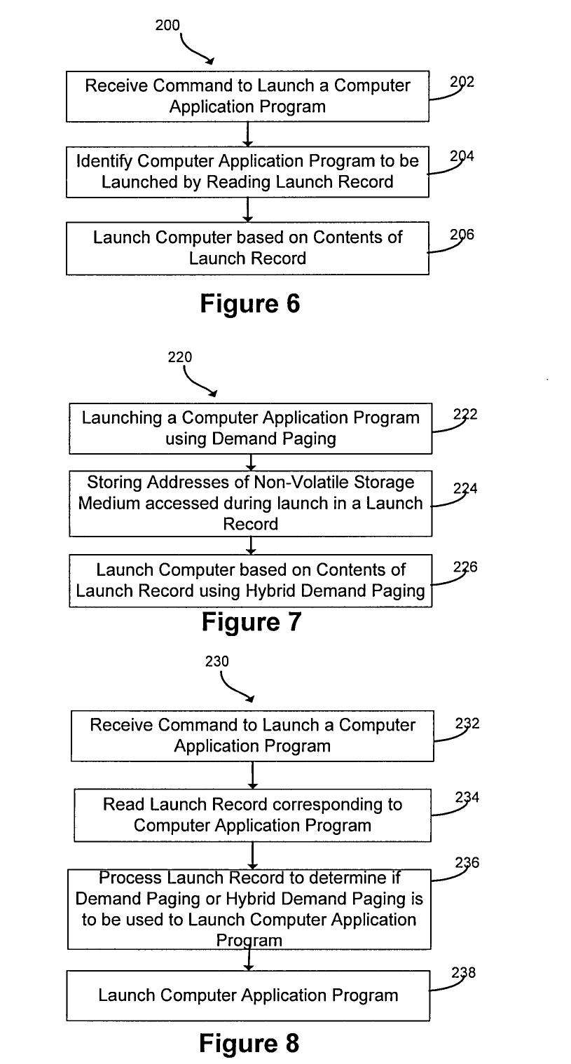

Referring to FIG. 6, an exemplary method 200 for launching a computer application program stored in a nonvolatile medium (e.g., memory 26, disk storage medium, etc.), is illustrated. The method 200 includes, at block 202, receiving a command to launch a computer application program, wherein the computer application program is stored on one or more pages of a nonvolatile medium. The computer application program may be stored in any type of nonvolatile medium (e.g., memory 26, disk storage medium, etc.). The command to launch a computer application program may be initiated by a user, the control circuit 48, by another application or by any other means.

At block 204, the computer application program to be launched is identified. Identification of the computer application program to be launched may include identifying a launch record associated with the computer application program to be launched.

An exemplary launch record may take a variety of forms. For example, in one embodiment, the launch record may contain an identification of the computer application program to be launched; a hybrid demand paging flag, which may be used to determine how pages of a nonvolatile medium are to be loaded into volatile memory; addresses of the one or more pages of the nonvolatile medium that were previously used to execute the computer application program by the electronic device; and one or more counters for each of the identified memory addresses. In addition, the launch record may include a counter field to count how many times a particular application has been launched, for example.

A launch record may be an initial (temporary) launch record or a final (established) launch record. A launch record is an initial (temporary) launch record when the computer application program has run less than a predetermined (e.g., a threshold) number of times. The predetermined number may be any desired number of times, including one. Preferably, the computer application program has been launched a number of times to provide a representative indication of the addresses of the nonvolatile medium that correspond to the device's most common execution of the computer application program.

A final launch record is a launch record associated with an application that has been launched more than the predetermined number of times. The launch record is deemed established by any of a variety of criterion. For example, each time a computer application program is launched a sub-record may be established for that specific launch. The sub-record stores each address used to launch the computer application program. In addition, one or more counters may be associated with each of the stored addresses. For example, a first counter may be used to indicate whether a page of memory was used in the launch and a second counter may be used to keep track of the total number of time an address was used in the launch.

Once the computer application program has launched the predetermined amount of times, the launch record may be fixed to a subset of all specific memory addresses stored in one or more of the sub-records associated with launch record. For example, if a certain memory locations were used in one-half or more of the launchings of the computer application program, it may be desirable to include these memory locations in an established launch record, as discussed above. Of course, other metrics may be used to populate the memory locations of the established launch record. For example, while the establish launch record may be used to launch the computer application program, sub-records associated with the launch record may be used to determine if one or more addresses should be added and/or deleted from the final launch record. For example, over a period of time a user's use of a computer application program may change. Therefore, it may be desirable to update the final launch record accordingly.

As set forth above, each computer application program that may be launched may include a separate launch record. The launch records associated with computer application programs that may be launched are stored in a nonvolatile medium (e.g., memory 26, disk storage medium, etc) when the electronic device is in an “on” state. For example, when the application has been requested by user or by the system, the available launch records that are stored in the nonvolatile medium may be loaded into volatile memory for quicker access to the launch records.

At block 206, the computer application program is launched by reading the launch record and loading the one or more pages of the nonvolatile medium identified in the launch record into a volatile memory for execution of the computer application program. The pages of the nonvolatile medium are read through a single read or one or more continuous reads are used to load the pages of the nonvolatile medium identified in the launch record in the volatile memory. Such a loading is referred to herein as hybrid demand paging.

Hybrid demand paging is distinct from demand paging. In demand paging, code pages are requested from the nonvolatile medium when actually needed for execution. In hybrid demand paging, a launch record is established for one or more computer application programs that are executed on the electronic device. The launch record stores the pages of nonvolatile medium that have been used during previous launches of the program (e.g., launches of the program that utilized demand paging). In hybrid demand paging, the address pages stored in the launch record are accessed in a single read or a continuous read to expedite loading of portions of the computer application program that are likely to be executed. Generally, the hybrid demand paging utilizes a single read or one or more continuous reads are that are substantially un-interrupted.

In one embodiment, the computer application program is launched a predetermined number of times using demand paging. Address pages associated with each launching and execution of the computer application program on the electronic device are monitored and stored in the launch record, as described above. For example, a computer application program may be launched several times (e.g., ten (10) times) to determine an optimal number of address pages of the nonvolatile medium to be loaded into volatile memory. One of ordinary skill in the art will appreciate that the number of predetermined times to launch an application program to determine an optimal transfer of address pages of a nonvolatile medium to volatile memory may vary on a number of factors including, for example, the type of computer application program, type of device, user preferences, actual use of the computer application program by a user, etc.

Once the computer application program has launched the predetermined number of times, the launch record may have a field for indicating that hybrid demand paging is appropriate for launch of the computer application program. For example, once the computer application program has launched the predetermined number of times there is sufficient data available in the launch record to determine which pages of the nonvolatile medium are desired for an optimal launch. In one embodiment, a flag may be set in the launch record (e.g., a hybrid demand page flag). When the hybrid demand page flag is set, the default transfer of pages from the nonvolatile medium to volatile memory (e.g., demand paging or store and download) is accomplished by hybrid demand paging. As stated above, in hybrid demand paging, the page addresses of nonvolatile mediums stored in the launch record are accessed in a single read or a continuous read to expedite loading of portions of the computer application program from the nonvolatile medium to volatile memory that are likely to be executed. Generally, the hybrid demand paging utilizes a single read or one or more continuous reads are that are substantially un-interrupted.

Another exemplary method 220 for launching a computer application program stored in a nonvolatile medium is illustrated in FIG. 7. The method 220 includes, at block 222, launching a computer application program one or more times using demand paging to load memory pages of a nonvolatile medium associated with the computer application program into a volatile memory for execution of the computer application program.

At block 224, memory address information corresponding to the memory pages of the nonvolatile medium corresponding to portions of the computer application program accessed during use of the computer application program are stored in a launch record, which is associated with the computer application program that has been launched.

At block 226, the computer application program is launched using hybrid demand paging. That is, the computer application program is launched using the address information stored in the launch record by loading the pages of the nonvolatile medium into volatile memory in a single read step or consecutive read steps, which are substantially un-interrupted.

Another exemplary method 230 for launching a computer application program stored in a nonvolatile medium is illustrated in FIG. 8. The method 230 includes, at block 232, receiving a command to launch a computer application program, wherein the computer application program is stored on one or more pages of a nonvolatile medium (e.g., a memory, a hard disk storage medium) of an electronic device. At block 234, a launch record associated with computer application program is read, wherein the launch record is stored in volatile memory.

At block 236, the launch record is processed to determine if demand paging or hybrid demand paging is to be used to load one or more pages of the nonvolatile medium associated with the computer application program into a volatile memory. For example, the field of the launch record that contains the hybrid demand paging flag may be examined. In one embodiment, if the hybrid demand field has been set then hybrid demand paging may be used to launch the computer application program. If the hybrid demand field not been set then another launch process may be used, e.g., demand paging. If demand paging is to be used, the computer application program is loaded from pages of the nonvolatile medium into volatile memory when needed by the electronic device. If hybrid demand paging is to be used, the computer application program obtains the memory address information contained in the launch record and reads the memory addresses associated with the nonvolatile medium in a single read step or consecutive read steps, which are substantially un-interrupted. At block 238, the computer application program is launched according to determination made at block 236.

In summary, a plan for launching one or more computer application programs is defined. For example, a program may utilize store and download, demand paging or hybrid demand paging. For purposes of this discussion, it is assumed that hybrid demand paging is desired. For hybrid demand paging, a launch record is created for data related to the launch of a computer application program. The launch record may include a flag to signify if hybrid demand paging exists for launching of a particular computer application. In one embodiment, a number of trials (e.g., a predetermined number of computer application launches) may be desired to enable hybrid demand paging, which will enable a more accurate reflection of memory page data associated with a particular computer application. The launch record may include memory page data containing logical block addresses of pages that define an optimal application launch for one or more computer applications. When the computer application program is launched that has not been enabled for hybrid demand paging, the computer application will be launched using demand paging in a conventional manner, wherein each of fetched addresses will be stored in a temporary address chain buffer for storing in the launch record.

When the number of launches for a computer application program reaches the predetermined number of trials, the computer application program may then be enabled for hybrid demand paging. The temporary chain of buffers may be analyzed in order to find most optimal launch scheme. It might be that most common scheme will be chosen, superset of the launching schemes or some combination. An algorithm may be used to choose the optimal launch scheme. This optimal scheme will be stored in the launch record to define page data containing logical block addresses of pages that define the optimal application launch or another application launch sequence. When launching a computer application that has been enable with hybrid demand paging, all memory pages of the nonvolatile medium contained in the logical block addresses of pages will be read by one sequential read operation. Afterwards, the standard demand paging mechanism will be enabled to allow fetching a memory pages that are not in volatile memory.

It will be apparent to a person having ordinary skill in the art of computer programming, and specifically in application programming for camera, mobile telephones and/or other electronic devices, how to program the electronic device 20 to operate and carry out logical functions associated with launching a computer application programs utilizing hybrid demand paging and how to program the electronic device 20 to operate and carry out logical functions associated with launching of computer application program utilizing hybrid demand paging. Accordingly, details as to specific programming code have been left out for the sake of brevity. Also, while the functions and may be executed by respective processing devices in accordance with an embodiment, such functionality could also be carried out via dedicated hardware or firmware, or some combination of hardware, firmware and/or software. Thus, hybrid demand paging defines a method for optimal launching of new applications by reusing the page load scheme from a standard demand page based launch.

Although certain embodiments have been shown and described, it is understood that equivalents and modifications falling within the scope of the appended claims will occur to others who are skilled in the art upon the reading and understanding of this specification.

What is claimed is:

1. A method for launching a computer application program stored in a nonvolatile medium of an electronic device, the method comprising:
receiving a command to launch a computer application program, wherein the computer application program is stored on one or more pages of a nonvolatile medium of an electronic device;
identifying the application program to be launched, wherein the step of identifying includes reading a launch record associated with the application program, wherein the launch record includes addresses of the one or more pages of the nonvolatile medium that were previously used to execute the computer application program; and
launching the computer application program by reading the launch record and loading the one or more pages of nonvolatile medium into a volatile memory for execution of the computer application program, wherein a single read or one or more continuous reads are used to load the one or more pages of the nonvolatile medium identified in the launch record in the volatile memory.

2. The method of claim 1, wherein the launch record is created by performing demand paging to launch the computer application program.

3. The method of claim 2, wherein the computer application program is launched a predetermined number of times and nonvolatile addresses associated with launching and execution of the computer application program are monitored and stored in the launch record.

4. The method of claim 3, once the computer application program has launched the predetermined number of times, the launch record has a hybrid demand paging flag set, wherein the hybrid demand paging flag signifies that the computer application program is to be launched based on information stored in the launch record.

5. The method of claim 3, wherein the predetermined number of times of the computer application launching is less than ten launches of the computer application program.

6. The method of claim 1, wherein a user initiates launching of the computer application program.

7. The method of claim 1, wherein the volatile memory is a Random Access Memory (RAM).

8. The method of claim 1, wherein the single read or one or more continuous reads are used to load the computer application program to be launched.

9. The method of claim 1, wherein launch records associated with launched computer application programs are stored in nonvolatile medium and loaded in volatile memory when the electronic device is in an “on” state.

10. The method of claim 1, wherein each of the launch records include a field to identify a type of memory read to launch the computer application program and one or more nonvolatile medium locations associated with use of the computer application program, wherein the nonvolatile medium locations include addresses that were obtained by direct paging of the nonvolatile medium from one or more previous launches of the computer application program.

11. A method for launching a computer application program stored in a nonvolatile medium, the method comprising:
launching a computer application program one or more times using demand paging to load pages of a nonvolatile medium associated with the computer application into a volatile memory for execution of the computer application program;
storing address information corresponding to the pages of the nonvolatile medium corresponding to portions of the computer application program accessed during use of the computer application program, wherein the memory address information is stored in a launch record that is associated with the computer application;
launching the computer application program using the address information stored in the launch record to read nonvolatile medium addresses stored in the launch record in a single or consecutive read step.

12. The method of claim 11, wherein the read step of claim 11 is performed continuously until the computer application program to be loaded is launched.

13. The method of claim 11, wherein the launch record is created upon performing demand paging to load the volatile memory with contents of the nonvolatile medium associated with the computer application program to launch the computer application program.

14. The method of claim 11, wherein each time the computer application program is launched by demand paging, nonvolatile storage addresses associated with launching and execution of the computer application program are monitored and stored in the launch record.

15. The method of claim 14, once the computer application program has launched the predetermined number of times, the launch record has a hybrid demand paging flag set, wherein the hybrid demand paging flag signifies that the computer application program is to be launched based on information stored in the launch record.

16. The method of claim 11, wherein launch records associated with launched computer application programs are stored in a nonvolatile medium and loaded in volatile memory when the electronic device is in an “on” state.

17. The method of claim 11, wherein each of the launch records include a field to identify a type of nonvolatile storage read to launch the computer application program and one or more nonvolatile medium locations associated with use of the computer application program, wherein the nonvolatile medium locations include addresses that were obtained by direct paging of the nonvolatile medium from one or more previous launches of the computer application program.

18. A method for launching a computer application program stored in a nonvolatile medium of an electronic device, the method comprising:
receiving a command to launch a computer application program, wherein the computer application program is stored on one or more pages of a nonvolatile medium of an electronic device;
reading a launch record associated with computer application program, wherein the launch record is stored in volatile memory; and
processing the launch record to determine if demand paging is to be used to load one or more pages of nonvolatile medium into a volatile memory, wherein each of the one or more pages are loaded into volatile memory when needed by the electronic device or hybrid demand paging is to be used to load the one or more pages of nonvolatile medium into the volatile memory, wherein hybrid demand paging utilizes address information stored in the launch record, wherein the address information includes each of the one or more pages of nonvolatile medium previously used by the electronic device when the computer application program previously executed and the volatile memory is loaded with the contents identified by the address information in a single or consecutive read steps.

19. The method of claim 18, wherein the address information stored in the launch record is accumulated by loading the computer application program using demand paging.

20. An electronic device comprising:
a nonvolatile medium for storing one or more computer application programs wherein the computer application program is stored on one or more pages of the nonvolatile medium;
a volatile memory for launching the one or more computer application programs;
a controller coupled to the nonvolatile medium and the volatile memory, wherein the processor receives a request to launch one or more of the computer application programs, the controller is configured to:
read a launch record associated with the one or more application programs, wherein the launch record includes addresses of the one or more pages of the nonvolatile medium that were previously used to execute the computer application program; and
launching the computer application program by reading the launch record and loading the one or more pages of nonvolatile medium into a volatile memory for execution of the computer application program, wherein a single read or one or more continuous reads are used to load the one or more pages of the nonvolatile medium identified in the launch record in the volatile memory.

21. An electronic device comprising:
a nonvolatile medium for storing one or more computer application programs wherein the computer application program is stored on one or more pages of the nonvolatile medium;
a volatile memory for launching the one or more computer application programs;
a controller coupled to the nonvolatile medium and the volatile memory, wherein the processor receives a request to launch one or more of the computer application programs, the controller is configured to:
launch the one or more computer application programs one or more times using demand paging to load the memory pages of nonvolatile medium associated with the computer application into the volatile memory for execution of the computer application program;
store memory address information corresponding to the memory pages of the nonvolatile medium corresponding to portions of the computer application program accessed during use of the computer application program, wherein the memory address information is stored in a launch record that is associated with the computer application; and
launch the computer application program using the address information stored in the launch record to read memory addresses stored in the launch record in a single or consecutive read step.
